(19) United States
(12) Patent Application Publication
(10) Pub. No.: US 2026/0101918 A1
(43) Pub. Date: Apr. 16, 2026

(54) TCM HERBAL SUPPLEMENT TO SUPPORT HEART HEALTH

(71) Applicants: Dalong Zhang, Santa Clara, CA (US); Xinghe Chen, Santa Clara, CA (US); Eva Chen, Santa Clara, CA (US)

(72) Inventors: Dalong Zhang, Santa Clara, CA (US); Xinghe Chen, Santa Clara, CA (US); Eva Chen, Santa Clara, CA (US)

(73) Assignee: Maishen Inc., Santa Clara, CA (US)

(21) Appl. No.: 18/912,222

(22) Filed: Oct. 10, 2024

(51) Int. Cl. A23L 33/00; A23L 33/105; A23L 33/11

(52) U.S. Cl. CPC A23L 33/30; A23L 33/105; A23L 33/11

(57) ABSTRACT

Disclosed herein are herbal and chemical combinations for promoting heart health. The herbal composition is used to relieve post-Covid symptoms. This composition creates a synergy between different ingredients that works to provide energy for post-Covid symptoms including fatigue. The composition comprises of Radicis Angelicae Sinensis (Dang Gui), Radix Rehmanniae Preparata (Shu Di Huang), Radix Paeoniae Rubrae (Shi Gao), Rhizoma Ligustici (Chuanxiong), Flos Carthami (Hong Hua), Radix Codonopsis (Dan Shen), Fructus Trichosanthis (Gua Lou), Cordyceps (Chong Cao). The herbs in the composition can include, among others, green tea ginger, cocoa, and yerba mate. Other chemicals in the composition can include, among others, caffeine and a pharmaceutically acceptable salt of calcium. The effectiveness of the herbal tea is at least partially dependent on the desired means of preparation and administering the composition.

### FIELD OF THE INVENTION

The present invention relates generally to a post-Covid relief herbal beverage method and composition. Further, the present invention relates to an herbal method and composition that balances the circulation of Qi and blood, nourishing and balancing the energy of the Five Organs, including the heart, lungs, liver, spleen, and the kidneys, through a unique method of preparing a composition consisting of the Chinese herbal medicine.

### BACKGROUND OF THE INVENTION

Most individuals with Long COVID start experiencing symptoms shortly after their initial COVID-19 infection, but some are unaware of when they were infected. People can be reinfected with SARS-CoV-2 multiple times, and each infection carries a risk of developing Long COVID. Symptoms and conditions associated with Long COVID can emerge, persist, resolve, and reemerge over weeks and months. These symptoms can range from mild to severe, may require comprehensive care, and can even lead to disability. Although the incidence of new Long COVID cases has declined since the beginning of the pandemic, it remains a significant public health concern, affecting millions of adults and children in the United States.

Individuals with Long COVID can experience a diverse array of symptoms, ranging from mild to severe, which may resemble those of other illnesses. These symptoms can persist for weeks, months, or even years after the initial COVID-19 infection and may emerge, persist, resolve, and reemerge over varying periods. The effects of Long COVID are not uniform, as each individual may be affected differently. Some people may encounter health issues from different types and combinations of symptoms that can be difficult to recognize or diagnose, require comprehensive care, and result in disability.

Some individuals with Long COVID experience symptoms that are difficult to explain or manage. Currently, there is no laboratory test that can definitively determine if these unexplained symptoms are due to Long COVID. Consequently, people with these symptoms may face misunderstanding or stigma, leading to delays in diagnosis and appropriate care. Treatment for Long COVID primarily focuses on symptom management, reducing their impact on daily activities, and enhancing quality of life.

Some individuals, particularly those who experienced severe COVID-19, may suffer from multi-organ effects or autoimmune conditions that persist for weeks, months, or even years after the initial illness. These multi-organ effects can impact various body systems, including the heart, lungs, kidneys, skin, and brain, and their symptoms often resemble those commonly reported in Long COVID. Consequently, people who have had COVID-19 may be at an increased risk of developing new or worsening health conditions, such as diabetes, heart conditions, blood clots, or neurological conditions.

Post-Covid virus can persist in a dormant state within the body, potentially leading to the reactivation of Covid symptoms in some cases. When these latent viruses are dormant and conditions such as decreased immunity or weather changes occur, they can become active again. Typically, patients experience a persistent dry cough with minimal sputum production during these periods. As the patient's immunity improves and their antiviral defenses strengthen, the virus may return to a dormant state, indicated when viral load falls below a certain threshold, such as 60 points. Consequently, dry cough symptoms may diminish or disappear. However, this cycle of recurring dry cough symptoms can be disruptive and distressing for the patient.

TCM teaches that bacteria and viruses can enter the body through the nose, mouth, skin wounds, eyes, or other openings, highlighting the importance of good personal hygiene to prevent infections. In 220 AD, the Chinese physician Ye Tian Shi introduced a framework for categorizing the severity of warm diseases, identifying Six Stages. He later developed the Four Levels to explain how these infectious diseases penetrate the body. Ye Tian Shi observed that these conditions were contagious, often accompanied by fever, rapidly advancing symptoms, and detrimental effects on the patient's Yin. Warm diseases encompass a range of disorders, including viral infections, Ebola, influenza, epidemics, tuberculosis, glandular fever, and SARS.

The Pericardium is frequently impacted by warm illnesses, with the primary issue being Heat disturbing the Shen. This is often referred to as Heat collapsing into the Pericardium and typically occurs during the Ying or Blood stage. When the Pericardium is affected in this manner, the Shen may become unclear, potentially resulting in coma or delirium. Initial indicators of this collapse often include significant irritability and a trembling tongue. Another common pattern that can affect the Shen, particularly in conjunction with External Heat illnesses, is Mucus obstructing the Pericardium.

Post-COVID, patients typically experience tiredness, sleepiness, fatigue, weakness, lack of energy, and difficulty concentrating. These symptoms are common sequelae of COVID-19. For individuals with a weak pulse, replenishing qi and blood and restoring physical strength can enhance immunity and alleviate fatigue. Even after addressing the symptoms associated with a weak pulse, it may take at least three months for patients to fully regain their previous strength. To completely combat fatigue, Traditional Chinese Medicine (TCM) should focus on regulating the heart and pericardium, strengthening the kidneys, and replenishing Yang, Qi, and Blood. This is especially important for those who are physically weak and experience loss of appetite or reduced food intake; they should prioritize replenishing Qi.

Chinese thought tends to focus on dynamic functional activity rather than fixed somatic structures. Chinese medical concepts can be evaluated using Western techniques to determine their efficacy. Studies have shown that Chinese medicine can be effective when assessed by Western standards, even though the treatments are often based on a non-Western theoretical framework. For example, Chinese medicine can address disharmonies that Western medicine associates with thyroid conditions. While a Western doctor might treat the thyroid directly through biochemical or surgical methods, a Chinese physician might treat the Heart or, depending on the overall pattern of symptoms, the Liver, Spleen, Kidneys, or a combination of these organs. The two paradigms approach the person differently, without a simple correspondence.

Blood and Qi is one of the main concepts of Traditional Chinese Medicine (TCM). Though generally distinct from each other, they share a mutually dependent and inseparable relationship. Qi generates and circulates the Blood, while also keeping it in place. Conversely, Blood nourishes the Organs that produce and regulate Qi. Their dynamic interplay of tension and ease, desire and acceptance, exemplifies the principles of Yin (Blood) and Yang (Qi). A traditional saying encapsulates this relationship with two principles: “Qi is the commander of the Blood . . . Blood is the mother of Qi.” In the holistic approach of Traditional Chinese Medicine (TCM), Organs are always discussed in terms of their functions and their relationships with fundamental textures, other Organs, and various parts of the body. An organ is defined solely through these relationships. The Organs are seen as bundles or intersecting matrices of resonating human activity. The relationships described here are those that the Chinese medical tradition considers most crucial for the clinical perception of patterns.

Deficient Qi affects the entire person, leading to symptoms such as lethargy and exhaustion. It can manifest as various feelings, including “not being able to do things,” “not wanting to do things,” or “not being able to want to do things.” Deficient Qi may also describe a specific organ's inability to perform its functions. For instance, in the pattern of Deficient Kidney Qi, the kidneys may struggle to regulate water harmoniously, causing symptoms like incontinence or edema. Deficient Qi can affect any type of Qi; for example, deficient protective Qi can result in frequent colds.

Stagnant Qi, another major type of Qi disharmony, disrupts the normal movement of Qi, preventing it from flowing smoothly and orderly through the body. Stagnant Qi in the limbs and meridians can cause pain and aches, while stagnation in an organ can impair its function. For instance, Stagnant Qi in the liver may lead to abdominal distention, moodiness, or a sense of frustration.

Blood originates from the transformation of food. After the stomach receives and processes the food, the Spleen extracts a fine, purified essence from it. The Spleen Qi then transports this essence upward to the Lungs. During this upward movement, Nutritive Qi begins transforming the essence into Blood. This transformation is completed in the Lungs, where the essence combines with the “clear” portion of air. This combination produces Blood, which is then circulated throughout the body by the Heart Qi, in coordination with the Qi of the Chest.

Three organs in the body have special relationships with the Blood: the Heart, Liver, and Spleen. Blood relies on the Heart for its harmonious, smooth, and continuous circulation throughout the body, hence the saying, “the Heart rules the Blood.” When the body is inactive and requires less Blood, the Liver stores it, demonstrating that “the Liver stores the Blood.” Lastly, Blood depends on the retentive properties of Spleen Qi to keep it within the blood vessels, which is why “the Spleen governs the Blood.”

Blood and Qi, though generally distinct, share a mutually dependent and inseparable relationship. Qi generates and moves Blood while also keeping it in place. In turn, Blood nourishes the organs that produce and regulate Qi. Their interplay of tension and ease, desire and acceptance, exemplifies the principles of Yin (Blood) and Yang (Qi). A traditional saying encapsulates this relationship: “Qi is the commander of the Blood... Blood is the mother of Qi.”

Chinese medicine recognizes five Yin Organs (Wu-zang) and six Yang Organs (Liu-fu). The Yin Organs include the Heart, Lungs, Spleen, Liver, and Kidneys, with the Pericardium sometimes considered a sixth Yin Organ. The Yin Organs are responsible for producing, transforming, regulating, and storing fundamental textures such as Qi, Blood, Essence, Spirit, and Fluids. The six Yang Organs are the Gall Bladder, Stomach, Small Intestine, Large Intestine, Bladder, and Triple Burner. These Yang Organs receive, break down, and absorb nutrients from food that will be transformed into fundamental textures, while also transporting and excreting the unused portion. Yin Organs are considered to be deeper within the body, making them Yin in relation to the more external Yang Organs. In medical theory and practice, the Yin Organs are generally regarded as more important.

“The Heart stores the spirit.” The Heart holds the small Spirit component of a person's entire Spirit, ensuring connection and interaction with the world of time and space. This Heart Spirit guarantees that consciousness, intention, volition, thought, reflection, and self-awareness within the larger composite Spirit align properly. It is responsible for appropriate behavior, timely interactions, and contextually suitable actions. Virtues like respect, helpfulness, thoughtfulness, or emotional responses are only meaningful when the Heart Spirit ensures the moment is right. The Heart's small Spirit keeps the larger composite Spirit on target.

The Heart Spirit guides the larger Spirit into the world of manifestation. For instance, intending to take an elderly person shopping is helpful if done before the shopping trip, not afterward. The Heart Spirit ensures proper timing. Wearing a bathing suit with a towel around your neck is appropriate at poolside but not in front of businesspeople during a financial negotiation. Similarly, figuring out the details of a money deal before going to sleep is likely poor timing. The Heart Spirit ensures that actions are suitable for their particular context and setting.

When the Heart Spirit is disturbed, symptoms such as insomnia, situational anxiety, and inappropriate or bizarre behavior may arise. Discomfort in social situations, along with physical signs of anxiety like sweating, blushing, being flustered, and palpitations, are often linked to the Heart. When the Heart Spirit is intact, one interacts with propriety and tact.

“The Heart opens into the tongue” and “the Heart's brilliance manifests in the face.” Tradition also says that “the tongue is the sprout of the Heart.” The ability to choose words precisely, convey meaning effectively, and engage in meaningful dialogue is attributed to the Heart Spirit's relationship with the tongue. Expressing warmth and appropriate engagement through facial expressions is another function of the Heart. Physically, the connection between the Heart and tongue means that tongue issues like ulceration and inflammation can often be treated with acupuncture or herbal therapy targeting the Heart. Stuttering is also linked to the Heart.

“The Heart rules the Blood and Blood Vessels.” The Heart regulates the flow of Blood. When Heart Qi (partly related to the heartbeat) and Heart Blood (which are mutually dependent) are abundant and normal, the pulse will be even and regular. Heart Blood is crucial for treating insomnia, as it “embraces” the Heart Spirit, allowing it to peacefully disconnect from the world. Short-term memory also depends on Heart Blood's ability to gently connect to time and place, as one must “let go” with the Blood for memories to flow back.

### SUMMARY OF THE INVENTION

This invention generally relates to extracts of several processed herbal medicinal plants and an herbal tea composition for ingestion which contains the extract. The invention's composition is used to increase and regulate the Blood and Qi of the heart. This composition creates a synergy between different ingredients that works to increase blood circulation and Qi regulation.

The invention is due, in part, to the unexpected finding that administration of the present invention's composition relieves fatigue and weak pulse, diagnosable conditions in TCM. TCM diagnose fatigue, weak pulse, and Long-Covid by examining patients'pulse speed, tongue coating, color of the sputum, and color of the nasal mucus. The present invention's composition is at least used to relieve symptoms of fatigue and weak pulse from Long-Covid.

In a preferred embodiment of the present invention, the composition includes Dang Gui, Shu Di Huang, Shi Gao, Chuan Xiong, Hong Hua, Dan Shen, Gua Lou, and Chong Cao. The effectiveness of herbal tea is at least partially dependent on the desired means of preparation and administering the composition.

In one embodiment, the therapeutically effective amount comprises from between about 1 mg to about 14000 mg/day.

In a preferred embodiment of the present invention, the therapeutically effective amount comprises from between about 330 mg to 660 mm/day.

In a preferred embodiment of the present invention, the therapeutically effective amount is a dosage regiment of half of a bottle in the morning, and half of a bottle in the evening, wherein each bottle comprises about 330 mg of the composition.

In a preferred embodiment of the present invention, the therapeutically effective amount is a dosage regiment of one bottle in the morning, and one bottle in the evening, wherein each bottle comprises about 330 mg of the composition.

In one embodiment, the administration to the subject occurs between about 30 minutes to about 1 hour after consuming food.

In another embodiment, the composition is added with equal parts of water and heated over the stovetop or microwave, then administered to the subject.

In another preferred embodiment of the present invention, a method to brew an herbal beverage product has the following steps: the grinding together of all these aforementioned ingredients to obtain a dispersion of finely ground brewing particles, adding an aqueous solution to the ground particles, heating the aqueous solution from about room temperature to about boiling temperature, reduction of the aqueous liquid by simmering, filtering the aqueous liquid to obtain the first extract, adding an aqueous solution to the remaining solids of the first extract, heat the aqueous solution containing solids from the extract from about room temperature to about boiling temperature, reduction of the aqueous solution contain the first extract by simmering, filtering the aqueous solution containing solids from the first extract to obtain the second extract, combining both extracts to create a third extract, reducing the third extract with a condensing machine.

In another preferred embodiment of the present invention, a method to brew an herbal beverage product has the following steps: the grinding together of all these aforementioned ingredients to obtain a dispersion of finely ground brewing particles, adding an aqueous solution to the ground particles, heating the aqueous solution from about room temperature to about boiling temperature, reduction of the aqueous liquid by simmering, filtering the aqueous liquid to obtain the extract.

In another preferred embodiment of the present invention, the composition is administered in at least one of the following ways: oral, topical, suppository, intravenous, intradermic, intramuscular, and intraperitoneal.

In another preferred embodiment of the present invention, the composition includes at least one member selected from the group consisting of: a tablet, an orally disintegrating tablet, a pill, a dripping pill, a lozenge, a capsule, a cream, a granule, a suppository, and an oral liquid.

In another preferred embodiment of the present invention, the composition consists of a plurality of herbal ingredients prepared through processing methods, extraction methods, and purification methods.

In another preferred embodiment of the present invention, the processing methods include at least one member selected from the group consisting of: washing, steaming, extracting, roasting, herb frying, salt frying, honey frying, wine frying, earth frying, vinegar frying, calcining drying, heating, and grinding.

In another preferred embodiment of the present invention, the extraction methods include at least one member selected from the group consisting of: soaking, heating, steaming, evaporation, compressing, and solvent extraction with at least one of the following: water, alcoholic solvents mixed with water, petroleum ether, hexane, diethyl amine, diethyl ether, cyclohexane, tert-butyl alcohol, isopropanol, Acetonitrile, acetone, ethanol, methyl isobutyl ketone, isobutyl alcohol, 1-propanol, methyl ethyl ketone, 2-butanol, isoamyl alcohol, 1-butanol, diethyl ketone, 1-octanol, p-xylene, m-xylene, toluene, dimethoxyethane, benzene, butyl acetate, 1-chlorobutane, tetrahydrofuran, ethyl acetate, o-xylene, hexamethylphosphorus triamide, 2-ethoxyethyl ether. N,N-dimethylacetamide, diethylene glycol dimethyl ether, N,N-dimethylformamide, 2-methoxyethanol, pyridine, propanoic acid, 2-methoxyethyl acetate, benzonitrile, 1-Methyl-2-pyrrolidinone, hexamethylphosphoramide, 1,4-dioxane, acetic acid, acetic anhydride, dimethyl sulfoxide, chlorobenzene, ethylene glycol, diethylene glycol, propylene carbonate, formic acid, 1,2-dichloroethane, glycerin, carbon disulfide, 1,2-dichlorobenzene, methylene chloride, nitromethane, 2,2,2-trifluoroethanol, chloroform, 1,1,2-trichlorotrifluoroethane, carbon tetrachloride, and tetrachloroethylene.

In another preferred embodiment of the present invention, the purification methods include at least one member selected from the group consisting of: column separation, solvent partition, evaporation, and solvent precipitation.

One objective of the present invention is to provide an herbal composition that increases energy and a stronger pulse.

Another objective is to provide an herbal composition that consists of easily available herbal ingredients.

Other systems, devices, methods, features, and advantages will be or become apparent to one with skill in the art upon examination of the following drawings and detailed description. It is intended that all such additional compositions, systems, methods, features, and advantages be included within this description, be within the scope of the present disclosure, and be protected by the accompanying claims and drawings.

### DETAILED DESCRIPTION OF THE INVENTION

Aspects of the invention are disclosed in the following description directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the invention include the discussed feature, advantage or mode of operation.

The following description directed to the medicinal properties of individual herbs and mixture of herbs is based, at least in part, on the teachings of Traditional Chinese Medicine (“TCM”). As such, the properties attributed to the individual herbs and mixtures of herbs set forth herein are done so in a non-limiting manner. Any evidence to the contrary based on other understandings or changes in understanding regarding TCM, or past and future scientific research will not operate to affect the operability of embodiments set forth and claimed herein, as will be readily recognized by one having ordinary skill in the art.

The invention stems, in part, from the surprising discovery that the composition effectively alleviates post-COVID symptoms, including fatigue, which is recognized as a diagnosable condition in Traditional Chinese Medicine (TCM). TCM teaches that bacteria and viruses can enter the body through the nose, mouth, skin wounds, eyes, or other openings, highlighting the importance of good personal hygiene to prevent infections. In 220 AD, the Chinese physician Ye Tian Shi introduced a framework for categorizing the severity of warm diseases, identifying Six Stages. He later developed the Four Levels to explain how these infectious diseases penetrate the body. Ye Tian Shi observed that these conditions were contagious, often accompanied by fever, rapidly advancing symptoms, and detrimental effects on the patient's Yin. Warm diseases encompass a range of disorders, including viral infections, Ebola, influenza, epidemics, tuberculosis, glandular fever, and SARS.

The Pericardium is frequently impacted by warm illnesses, with the primary issue being Heat disturbing the Shen. This is often referred to as Heat collapsing into the Pericardium and typically occurs during the Ying or Blood stage. When the Pericardium is affected in this manner, the Shen may become unclear, potentially resulting in coma or delirium. Initial indicators of this collapse often include significant irritability and a trembling tongue. Another common pattern that can affect the Shen, particularly in conjunction with External Heat illnesses, is Mucus obstructing the Pericardium.

Post-COVID, patients typically experience tiredness, sleepiness, fatigue, weakness, lack of energy, and difficulty concentrating. These symptoms are common sequelae of COVID-19. For individuals with a weak pulse, replenishing qi and blood and restoring physical strength can enhance immunity and alleviate fatigue. Even after addressing the symptoms associated with a weak pulse, it may take at least three months for patients to fully regain their previous strength. To completely combat fatigue, Traditional Chinese Medicine (TCM) should focus on regulating the heart and pericardium, strengthening the kidneys, and replenishing Yang, Qi, and Blood. This is especially important for those who are physically weak and experience loss of appetite or reduced food intake; they should prioritize replenishing Qi.

The composition of the present invention consists of the following herbal ingredients mixed in varying weight percentages: Radicis Angelicae Sinensis, Radix Rehmanniae Preparata, Radix Paeoniae Rubrae, Rhizoma Ligustici Chuanxiong, Flos Carthami, Radix Codonopsis, Fructus Trichosanthis, Cordyceps The herbal ingredients aforementioned combine to create a synergy to suppress cough symptoms, improve the circulation of Qi and blood, and balances the forces of Yin and Yang. The present disclosure provides a novel mixture of the ingredients, including unique processing, extraction, and purification methods for optimizing efficacy of the herbal ingredients. The effectiveness of the composition is at least partially dependent on the desired means of preparation and administering the composition.

The individual herbal ingredients are efficacious for nourishing the Heart, replenishing and nourishing Qi and Blood for the Five Organs in the physical body to reduce or eliminate the symptoms of long-Covid. Those skilled in the art will recognize that TCM teaches that the Heart is the primary organ that regulates the qi and blood in the body. If the Heart is malnourished, so is the qi that circulates in the body.

### Radicis Angelicae Sinensis (Dang Gui)

One herbal ingredient is Radicis Angelicae Sinensis, known as Dang Gui in mandarin. Dang Gui is categorized as blood-tonifying, blood-invigorating, pain-relieving herb, used in TCM to tonify blood, increase blood circulation, moistens intestines, unblocks intestinal obstruction, and stops cough and treats dyspnea. Dang Gui dry-fried with grain-based liquor more strongly moves the blood, and is commonly used to treat mensutral pain, traumatic bruises and pain, and cases of blood stagnation.

Dang Gui treats symptoms of Heart and Liver blood deficiencies include enemia, pale complexion, brittle nails, dry hair dizziness, blurred vision, and palpitations. Dang Gui is warm in nature, most suitable for cold-type blood-deficient patients. It also treats abdominal pain related to blood deficiency and coldness. To treat blood and Qi deficiencies, Dang Gui is combined with Huang Qi (Radix Astragali), a formula of Dang Gui Bu Xiue Tang (Tangkuei Decoction to Tonify the Blood.

Because of the warm property of Dang Gui and its action to nourish the blood and invigorate circulation, Dang Gui is most suitable to treatment of cold types of menstrual disorders including irregular mensutural cycle, dysmenorrhea, amenorrhea, and other gynecological disorders. For example, to treat Amenorrhea due to blood deficiency and stagnation, the prescription includes a combination of Dang Gui with Hong Hua, Tao Ren, Chuan Xiong, and Chi Shao.

Dang Gui is acrid in taste, activates blood circulation and disperses blood stagnation. If blood stagnation is dispersed, swelling will automatically subside. Dang Gui is commonly used in trauma departments in hospitals in China, along with blood-activating herbs, to treat the following symptoms: bruises, fractured or broken bones, swelling, and injuries of the tendons.

Applied topically, Dang Gui reduces swelling, expels pus, generates flesh and relieves pain. Because it is warm and nourishing in nature, it is most suitable when taken internally for slow healing sores from qi and blood deficiencies. For slow-healing sores due to qi and blood deficiencies, Dang Gui is used independently, or in conjunction with Huang Qi, Jin Yin Hua, Gan Cao, Bai Zhi, and Da Zao for internally use.

When the bowels are not properly nourished by blood, constipation or dry stools result. Usually the elderly, or those who have chronic constipation, or are postpartum women, or are in late or recovery stages of chronic disorders suffer this type of constipation. Dang Gui nourishes the blood and moistens the intestines to promote bowel movement. For constipation due to blood deficiency, Dang gui is combined with He Shou Wu, Huo Ma ren, Tao Ren, Rou Cong Rong, Sheng Di Huang, Shu di Huang, and Da Huang.

To treat cough and dyspnea, shortness of breath, and profuse Sputum, Dang Gui is used in combination with Su Zi, Ban Xia, Hou Po, and Qian Hu to transform phlegm and stop cough.

Pharmacological effects of Dang Gui include effects on the uterus, cardiovascular, antiplatelet, Immunostimulant, respiratory, hepatoprotective, antibiotic, and analgesic and anti-inflammatory effects. For the effects on the uterus, administration of Dang Gui is associated with both stimulating and inhibiting effects on the smooth muscle of the uterus.

In one laboratory study using frog specimens, intravenous injection of Dang Gui was associated initially with an inhibitory influence on the heart, followed by a negative chronotropic effect and positive inotropic effect. It improves overall blood circulation by decreasing the whole blood specific viscosity, or improving the hemorrheological changes in “blood stagnation.” It also has an antiarrhythmic effect, especially against arrhythmia induced by epinephrine, cardiac glycosides, aconitine, and barium chloride, Administration of Dang Gui is associated with reduction of plasma cholesterol and triglyceride levels, and a decreased risk of atherosclerosis, as demonstrated in laboratory studies.

Extract of Dang Gui has analgesic and anti-inflammatory effects similar to those of acetylsalicyclic acid. It decreases vascular permeability to reduce inflammation. Its anti-inflammatory effect is approximately 1.1 times stronger than acetylsalicylic acid, and its analgesic effect is approximately 1.7 times stronger than acetylsalicyclic acid.

### Radix Rehmanniae Preparata (Shu Di Huang)

Another herbal ingredient is Radix Rehmanniae Preparata, known as Shu Di Huang in mandarin. Shu Di Huang is categorized as a blood-nourishing, kidney-liver-tonifying, and Jing-replenishing herb, used in TCM to treat blood deficiency, anemia, menstrual disorders, gestational and postpartum disorders, liver and kidney Yin deficiencies, thirsting syndrome, developmental delay and premature aging, and respiratory disorders.

Shu Di Huang treats blood decificency and the consequent lack of nourishment to the Liver and heart. Proper circulation of blood is dependent on the volume of blood being circulated. In anemic or blood-deficient patients, there is insufficient blood to nourish the organs. Typical signs include sallow or pale complexion, dizziness, palpitations, and insomnia. Shu Di Huang strongly nourishes and tonifies the blood.

Blood belongs to the yin element and is the foundation of women's health. Irregular menstruation is often caused by blood stagnation or blood deficiency. Because the rich nature of Shu Di Huang may cause stagnation, it should only be used for patients with irregular menstruation arising from blood deficiency, and not for those with blood stagnation.

Shu Di Huang treats restless fetus, habitual miscarriage, and postpartum complications. Shu di Huang is used as the main herb in formulas that treat lower abdominal pain, edema, nausea, and vomiting caused by deficiency from sudden loss of blood in postpartum women. For restless fetus or habitual miscarriage, combine it with Ren Shen, Bai Zhu, Dang Gui, Xu Duan, and Sha Ren.

Clinical presentations of liver and kidney yin deficiencies include soreness and weakness of the lower back and knees, dizziness, vertigo, tinnitus, diminished hearing, tidal fever, night sweats, nocturnal emissions, a thready, rapid pulse, and a dry, cracked tongue with scanty or no coating. Shu Di Huang nourishes the yin and blood of the Liver and Kidney.

According to one report, 62 patients with cardiovascular disorders were treated with 30 to 50 grams of Shu Di Huang daily for 2 weeks. There was a reductyion of blood pressure, total cholesterol levels, and triglycerides. There was also an improvement in cerebral blood flow and in ECG results. In another clinical study on retrogressive myelitis in 1,000 parties, administration of an herbal formula two to three times daily for 1 to 2 months provided significant improvement in 803 patients, moderate improvement in 141 patients, and no response in 56 patients. The herbal formula contained Shu Di Huang, Rou Cong Rong, Lu Han Cao, Gu Sui Bu, Yin Yang Huo, Ji Xue Teng, and Lai Fu Zi.

### Radix Paeoniae Rubrae (Chi Shao)

Another herbal ingredient is Paeoniae rubra, known as Chi Shao in mandarin. Chi Shao is categorized as a heat-clearing, blood-cooling, pain-relieving herb. Chi Shao dispels blood stasis, reduces swelling from sores and abscesses, relieves eye pain. Chi Shao treats various bleeding disorders caused by febrile disorders or heat attacking the blood. Chi Shao is often used to treat amenorrhea and dysmenorrhea. Blood stagnation in uterus leads to amenorrhea or dysmenorrhea with blood clots. The blood is often dark in color, and pain is alleviated after clots have been dispelled. To treat this condition, Chi Shao is added with Dang Gui (Radicis Angelicae Sinensis) and Chuan Xiong (Rhizoma Ligustici).

Chi Shao is chemically composed of paeoniflorin, benzoylpaeoniflorin, oxypaeoniflorin, lactiflorin, daucosterol, d-catechin. The pharmacological effects of Chi Shao are antiplatelet, hematological, cardiovascular, antispasmodic, antibiotic, antiseizure and antipyretic effects. In one study, 125 patients with coronary artery disease were treated with 40 grams of Chi Shao decoction three times daily, with satisfactory results. In another study, intravenous infusion of Chi Shao injectables with D5W or D10W once daily was 92.01% effective for prevention of thrombus formation in 263 patients. According to one report, 10 grams of Chi Shao given three times daily was effective in treating 30 patients with cor pulmonale.

### Rhizoma Ligustici (Chuan Xiong)

Another herbal ingredient is Rhizoma Ligustici Chuanxiong, known as Chuan Xiong in mandarin, categorized as a Qi-activating, wind-dispelling, and a pain-relieving herb, used to activate blood circulation, to treat irregular menstruation, amenorrhea, dysmenorrhea, child-birth-related disorders, pain due to blood and qi stagnation, and headaches. Chuan Xiong's pharmacological effects include cardiovascular, antiplatelet and anticoagulant, circulatory, sedative, and protective effect against radiation.

Chuan Xiong is acrid and warm, effective in activating blood circulation. It has excelent ascending, desscending and dispersing functions, and reaches every part of the body. Chuan Xiong is one of the best herbs to treat gynecological disorders. It is also added to blood-tonic herbs to prevent any stagnating side effects.

Chuan Xiong dispels wind and relieves pain. It is acrid and aromatic, ascending and dispersing, an essential herb in relieving all kinds of aches and pains, when combined with other herbs. In one study, 50 patients with headaches were treated with herbal formulas with great success. The base formula contained Chuan Xiong, Shi Gao, Xio Xin, and Ju Hua.

Eight patients with angina were treated with 20 mg of ferulic acid in 250 ml of D5W, administered via intravenous infusion once daily, for 10 days. The study reported an overall improvement of chest pain, ECG evaluation, and reduction of cholesterol levels. In another study, preparation of a Chuan Xiong injectable was used to treat 30 angina patients, with relief of pain observed in 92.5% of patients and improvement of ECG seen in 40% of patients.

### Flos Carthami (Hong Hua)

Another herbal ingredient is Flos Carthami, known as Hong Hua in mandarin, categorized as a blood-stasis-eliminating, channel-opening herb, used to activate blood circulation, gynecological disorders, abdominal masses or accumulations, joint pain, dermatological disorders, and chest pain.

Hong Hua functions extremely well to activate blood circulation and eliminate blood stasis. It has a broad range of clinical applications including menstrual pain, amenorrhea, postpartum abdominal pain, external and sports injuries, joint pain, and macular skin eruptions. Hong Hua is one of the most commonly-used herbs in the obstetric and gynecologic departments in China. When used in small dosages, it activates and nourishes blood. When used in large dosages, it breaks blood stagnation.

Hong Hua invigorates the circulation of blood in the channels and collaterals. Clinical manifestations include bi zheng (painful obstruction syndrome), hemiplegia or paralysis. Hong Hua has demonstrated marked effectiveness to inhibit the aggregation of platelets and formation of thrombi. It was reported in one study that Hong Hua is 73.4% effective in preventing the formation of thrombi in rats.

### Radix Codonopsis (Dan Shen)

Another herbal ingredient is Radix Codonopsis, known as Dang Shen in mandarin, categorized as a Qi-tonifying, blood-nourishing, and pathogen-expelling herb, used for strengthening the Middle Jiao, lung qi tonification, nourishing blood and body fluids. Dang Shen tonifies the spleen and stomach to enhance their transportation and transformation functions. It is commonly used to treat qi deficiency characterized by fatigue, lack of appetite, weak extremities, and diarrhea.

Dang Shen tonifies the Lung to treat coughing, wheezing, shortness of breath, and low voice from Lung deficiency. In true Lung deficiency, all of the above symptoms worsen with exertion. This herb tonifies the lung and is not drying in nature. Disorders characterized by lung qi deficiency is treated with Dang Shen, Huang Qi, Wu Wei Zi, Zi Wan, and Sang Bai Pi.

Dang Shen has an excellent effect to tonify qi, that in turn enhances the production of blood and body fluids. It is commonly used to treat cases of chronic illness characterized by qi and yin deficiencies, or qi and blood deficiencies.

Dang Shen is often used for patients with exterior conditions or interior excess meeting constitutional deficiency. This herb is mild, generates body fluids, and nourishes blood to help the body fight pathogenic factors. The most common clinical manifestations include common cold and constipation. Contraindicated for use alone in these conditions, Dang Shen should always be combined with appropriate herbs to expel the pathogenic factors.

For wind-cold with aversion to cold, fever, headache, nasal obstruction, cough and sputum, in a constitutionally deficient patient, Dang Shen is used with Zi Su Ye, Qian Hu, Ban Xia and Jie Geng to treat the symptoms.

Dang Shen is commonly used in both herbal decoction and pill forms. Dry-fried Dang Shen is more effective in strengthening the spleen and stops diarrhea. Honey-baked Dang Shen is stronger for tonifying the middle jiao and benefiting the qi.

Dang Shen has both stimulating and inhibiting effects on the central nervous system to help animals adapt to various stressful environments. According to studies, intraperitoneal injection of the herb greatly enhances resistance to hypoxia in mice.

Intravenous injection of water and alcohol extracts of Dang Shen has a temporary effect to lower blood pressure in anesthetized rabbits and dogs. In anesthetized cats, intravenous injection of the herb increases cardiac output and blood perfusion to the brain, lower extremities, and internal organs.

### Fructus Trichosanthis (Gua Lou)

Another herbal ingredient is Fructus Trichosanthis, known as Gua Lou in mandarin, categorized as a lung-clearing, phlegm-dissolving, pus-eliminating, and qi-expanding herb, used to treat cough, lung heat, obstruction of the chest, and abscess. Gua Lou is sweet and cold, moistens dryness, clears the lung and dissolves phlegm.

In addition to clearing the lung and dissolving phlegm, Gua Lou regulates qi circulation in the chest to relieve feelings of chest oppression and pain. Clinically, it treats obstructions of the chest caused by accumulation of heat and phlegm beneath the heart leading to congestion and oppression in the chest, increased pain upon pressure, and yellow, copious, sticky sputum. Chest obstructions may also be caused by stagnation of cold with yang deficiency manifesting in severe pain with an inability to lie down, as well as in wheezing, dyspnea, and cough. Gua Lou dissipates nodules and eliminates pus to treat abscesses of the lungs, intestines, or breasts.

Gua Lou has shown antibiotic effects. Water or alcohol extracts of the herb have an inhibiting influence in vitro against E. coli, Staphylococcus aureus, Diplococcus pneumoniae, α-hemolytic treptococcus, and Bacillus dyenteriae.

### Cordyceps (Chong Cao)

Another herbal ingredient is Cordyceps, known as Chong Cao in mandarin, categorized as a Kidney-and-Lung-Tonifying herb, used to treat kidney yang and jing deficiencies, chronic respiratory disorders and cough. Kidney Yang and Jing deficiencies is characterized by generalized soreness, lower back and knee weakness and pain, spermatorrhea, frequent urination, nocturnal emissions, impotence, premature ejaculation, tinnitus, forgetfulness, and poor memory. Chong Cao is also ideal for covalescing patients or those who are extremely weak, with spontaneous sweating.

What is claimed is:

1. A composition for provisioning an herbal tea to improve heart health, comprising a mixture of plant extracts, where in the mixture of plant extracts consists of at least one Cassia bark tree twig, at least one Dang Gui, at least one Shu Di Huang, at least one Shi Gao, at least one Chuan Xiong, at least one Hong Hua, at least one Dan Shen, at least one Gua Lou, and at least one Chong Cao.

2. The composition of claim 1, wherein said composition is in dry form.

3. The composition of claim 1, further comprising a caffeine extract.

4. The composition of claim 1, further comprising a sweetener composition.

5. The composition of claim 1, further comprising polyphenols.

6. The composition of claim 1, further comprising resveratrol.

7. The composition of claim 1, further comprising at least one additive selected from the group consisting of Ginseng, Ginger, Lycium, Chinese Blackberry, Lotus, Cinnamomum, Fennel, Jujube, Orange Peel, Hawthorn, Ephedra, Astragalus, Licorice, Epimedium, Xie Bai, Gui Zhi, Hei Fu Pian, Yan Hu Suo, Wu Ling Zhi, Mo Yao, Xiao Hui Xiang and combinations thereof.

8. The composition of claim 1, wherein the composition is administered orally.

9. The composition of claim 1, wherein the composition is administered topically.

10. The composition of claim 1, wherein the composition is administered intravenously.

11. The composition of claim 1, wherein the composition is administered intradermic.

12. The composition of claim 1, wherein the composition is administered intramuscular.

13. The composition of claim 1, wherein the composition includes at least one member selected from: a liquid beverage, an aqueous beverage, a tablet, an orally disintegrating tablet, a pill, a dripping pill, a lozenge, a capsule, a cream, a granule, and a suppository.

14. The composition of claim 1, wherein the composition consists of a plurality of herbal ingredients prepared through processing methods, extraction methods, and purification methods.

15. The composition of claim 1, wherein the processing methods include at least one member selected from the group consisting of: purification, grinding, pulverizing, soaking, heating, evaporation, compressing, washing, steaming, extracting, roasting, herb frying, salt frying, honey frying, wine frying, earth frying, vinegar frying, calcining and drying.
